(19) United States
(12) Patent Application Publication
(10) Pub. No.: US 2011/0205424 A1
(43) Pub. Date: Aug. 25, 2011

(54) LENS DRIVING DEVICE AND CAMERA MODULE MOUNTING LENS DRIVING DEVICE

(75) Inventors: Mituo Nakashima, Neyagawa-Shi (JP); Hiroshi Yamashita, Ichinomiya-Shi (JP); Satoru Ota, Osaka-Shi (JP); Yuma Aoi, Ichinomiya-Shi (JP)

(73) Assignee: SANYO Electric Co., Ltd., Moriguchi-shi (JP)

(21) Appl. No.: 13/100,728

(22) Filed: May 4, 2011

Related U.S. Application Data
(63) Continuation of application No. PCT/JP2009/064492, filed on Aug. 19, 2009.

(30) Foreign Application Priority Data
Nov. 11, 2008 (JP) 2008-288918

(51) Int. Cl. G02B 7/04; H04N 5/225

(52) U.S. Cl. 348/360; 359/823; 348/E05.028

(57) ABSTRACT

A lens driving device includes a holder which holds a lens and is movable in the direction of an optical axis of the lens and a plurality of magnets which is fixed to the holder so as to be separated from each other in a circumferential direction. Cut-out portions are provided on the holder and the magnets which are adjacent to each other in the circumferential direction are communicated with each other through the cut-out portions. When an adhesive is filled into the cut-out portions, the adhesive bonds the magnets which are adjacent to each other in the circumferential direction.

This application is a Continuation of PCT/JP2009/064492 filed Aug. 19, 2009 and claims priority under 35 U.S.C. Section 119 of Japanese Patent Application No. 2008-288918 filed on Nov. 11, 2008, entitled “LENS DRIVING DEVICE AND CAMERA MODULE MOUNTING LENS DRIVING DEVICE.” The disclosure of the above application is incorporated herein by reference.

### BACKGROUND OF THE INVENTION

1. Field of the Invention

The present invention relates to a lens driving device which moves a lens in the direction of an optical axis thereof and a camera module mounting the lens driving device.

2. Disclosure of Related Art

In recent years, in a camera mounted in a mobile phone, resolution has been advanced to be made higher and an auto-focus function has been indispensable. A lens driving device is used in order to perform auto-focus. On the other hand, a space provided for the lens driving device is increasingly needed to be reduced as the mobile phone is made thinner and reduced in size. In order to respond to the need, for example, a voice coil structure is employed as a structure for driving a lens in the lens driving device. In general, a configuration can be simplified in the voice coil structure in comparison with a structure using a stepping motor, thereby achieving reduction of the lens driving device in size.

In the voice coil structure, a coil is mounted on a holder which holds the lens and a magnet is mounted on a base. The holder is moved in the direction of an optical axis of the lens with an electromagnetic driving force generated by applying current to the coil. Further, the holder is supported by a spring member and the spring member is shared for feeding power to the coil. Thus, a wiring is not drawn out from the holder.

With this configuration, as stated above, the wiring for feeding power to the coil is not drawn out from the holder. Therefore, at the time of lens driving, damage of the wiring due to unnecessary vibration and tension applied to the wiring can be prevented from being occurred. However, on the negative side, since a structure of the spring member is complicated in the configuration, yield at the time of manufacturing of the lens driving device is easily deteriorated.

As a configuration for solving the above problem, a configuration in which a magnet is mounted on a holder and a coil is mounted on a base can be employed. With the configuration, since a wiring is not needed to be formed on the holder, the wiring can be prevented from being damaged at the time of the lens driving. Further, a configuration of a lens driving device is simplified by eliminating a spring member.

However, in the configuration, when an impact is applied from outside to the lens driving device, a large impact is applied to the holder which is movable. Accordingly, when bonding strength between the holder and the magnet is low, there may be occure that the magnet jounces with respect to the holder.

### SUMMARY OF THE INVENTION

A first aspect of the invention relates to a lens driving device. The lens driving device according to the first aspect of the invention includes a holder which holds a lens and is movable in the direction of an optical axis of the lens, and a plurality of magnets which surrounds the lens from a radial direction and is fixed to the holder so as to be separated from each other. In the lens driving device, communicating grooves through which the magnets which are adjacent to each other are communicated with each other and into which an adhesive is filled are provided on the holder. Further, in the lens driving device, the magnets which are adjacent to each other are bonded to each other with the adhesive filled into the communicating grooves.

A second aspect of the invention relates to a lens driving device. The lens driving device according to the second aspect of the invention includes a holder which holds a lens and is movable in the direction of an optical axis of the lens, and a plurality of magnets which surrounds the lens from a radial direction and is fixed to the holder so as to be separated from each other. In the lens driving device, adhesive sump portions are provided on the holder, the adhesive sump portion being configured such that hole shapes are formed between the adhesive sump portions and side surfaces of the magnets, and an adhesive is filled into each adhesive sump portion. Further, in the lens driving device, the magnets are fixed to the holder with the adhesive filled into the adhesive sump portions.

A third aspect of the invention relates to a camera module. The camera module according to the third aspect of the invention includes the lens driving device according to the above first or second aspect of the invention.

### BRIEF DESCRIPTION OF THE DRAWINGS

The above and other objects and novel characteristics of the invention are made obvious more perfectly by reading the following description of embodiments and the following accompanying drawings.

FIG. 1 is an exploded perspective view illustrating a configuration of a lens driving device according to an embodiment of the invention.

FIGS. 2A and 2B are cross-sectional views for explaining operations of the lens driving device according to the embodiment.

FIGS. 3A and 3B are a perspective view and a plan view illustrating a configuration of a holder of the lens driving device according to the embodiment.

FIGS. 4A and 4B are a plan view and a side view illustrating a holder in a state where magnets are attached in the lens driving device according to the embodiment.

FIG. 5A is a cross-sectional view cutting a movable member of the lens driving device according to the embodiment on a plan along an optical axis direction. FIG. 5B is a diagram enlarging a dashed-line circle in FIG. 5A. FIG. 5C is a cross-sectional view illustrating a relationship among depths of the magnets, a cut-out portion, and adhesive sump portions in the lens driving device according to the embodiment.

FIG. 6 is a flowchart illustrating a manufacturing process of the lens driving device according to the embodiment.

FIG. 7 is a schematic view illustrating a configuration of a camera module mounting the lens driving device according to the embodiment.

FIG. 8 is a plan view illustrating a configuration of a holder of a lens driving device according to a modification of the embodiment.

FIG. 9 is a plan view illustrating a configuration of a holder of a lens driving device according to another modification of the embodiment.

FIG. 10 is a plan view illustrating a configuration of a holder of a lens driving device according to still another modification of the embodiment.

FIG. 11 is a plan view illustrating a configuration of a holder of a lens driving device according to still another modification of the embodiment.

FIG. 12 is a plan view illustrating a configuration of a holder of a lens driving device according to still another modification of the embodiment.

It is to be noted that the drawings are intended to explain the invention only and are not intended to limit a range of the invention.

### DESCRIPTION OF PREFERRED EMBODIMENTS

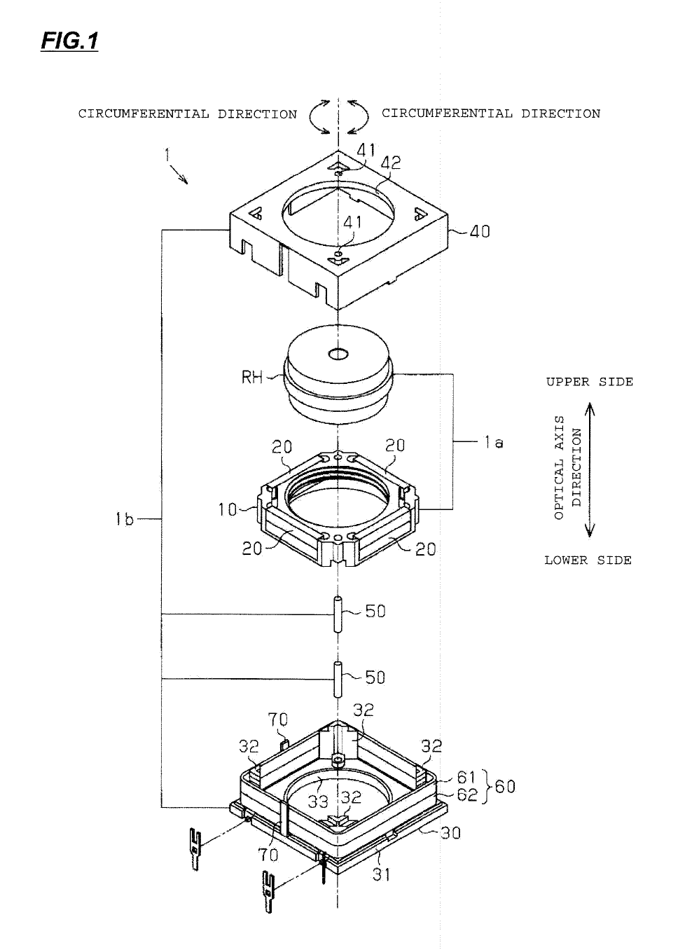

An embodiment according to the present invention is described with reference to FIG. 1 through FIG. 7. In the embodiment, the invention is applied to a lens driving device used for auto focus of a camera mounted in a mobile phone. Hereinafter, a direction along an optical axis of a lens is referred to as “optical axis direction”, a radial direction of the lens is referred to as “radial direction”, and a direction surrounding the optical axis of the lens is referred to as “circumferential direction”. Further, in the optical axis direction of a lens driving device 1, a side of a base 30 is referred to as “lower side” and a side of a case 40 is referred to as “upper side”. In the radial direction of the lens driving device 1, a side toward the optical axis is referred to as “inner side” and a side away from the optical axis is referred to as “outer side”.

At first, the entire configuration of the lens driving device 1 is described with reference to FIG. 1.

As illustrated in FIG. 1, the lens driving device 1 is constituted by a movable member 1a and a fixing member 1b. The movable member 1a is movable in the optical axis direction. The fixing member 1b applies a driving force to the movable member 1a and is fixed to equipment on which the lens driving device 1 is mounted. In the lens driving device 1, the lens is moved in the optical axis direction as the movable member 1a moves in the optical axis direction so that auto focus of a camera is realized. In the embodiment, the lens driving device 1 is formed into a square, approximately 8.5 mm on a side, when seen from the above in the optical axis direction. A height of the lens driving device 1 in the optical axis direction is approximately 3 mm.

The movable member 1a is constituted by a lens, a lens holder RH, a holder 10, and a plurality of magnets 20. The lens holder RH holds the lens. The holder 10 holds the lens holder RH. The plurality of magnets 20 is fixed to the holder 10. In the embodiment, four magnets 20 are fixed to the holder 10 with constant distances between the magnets 20 in the circumferential direction. As the magnets 20, neodymium magnets (Ne—Fe—B) are used. In particular, in the embodiment, neodymium sintered magnets each of which is formed into a plate form are used as the magnets 20.

The fixing member 1b is constituted by a base 30, a case 40, shafts 50, and a coil 60. The base 30 and the case 40 constitute an outer frame of the lens driving device 1. The shafts 50 are fixed to the base 30 and guides movement of the holder 10 in the optical axis direction. The coil 60 forms a magnetic field if current is applied thereto. Further, rectangular plate-form magnetic plates 70 formed by magnetic steel plates are fixed to the base 30 at the outer side of the coil 60 in the radial direction.

A base portion 31 and supporting column portions 32 are provided on the base 30. The base portion 31 constitutes a lower surface of an outer frame of the lens driving device 1. The supporting column portions 32 are provided so as to extend from the base portion 31 along the optical axis direction. The base portion 31 is formed into a square shape when seen from the above in the optical axis direction. Each supporting column portion 32 is provided on each of four corners of the base portion 31. Further, an opening 33 as a circular through hole is formed at a center position of the base portion 31. Two magnetic plates 70 are fixed to the circumferential edge of the base 30 at two places. To be more specific, each of the magnetic plates 70 is fixed at a center position on each of sides constituting the circumferential edge of the base 30.

The case 40 constitutes outer-side side surfaces and an upper surface of the lens driving device 1. The case 40 is attached to the base 30 so as to surround the outer side of the coil 60 in the radial direction. Further, two through holes 41 and an opening 42 are provided on an upper surface of the case 40. The shafts 50 are inserted into the two through holes 41. The movable member 1a can be inserted into the opening 42.

One ends of the shafts 50 are fixed to the base portion 31 of the base 30 and the other ends thereof are inserted into the through holes 41 of the case 40. With this, the shafts 50 are held by the base 30 and the case 40 so as to be along the optical axis direction. The shafts 50 are inserted into through holes of the holder 10. In this manner, the holder 10 can slide with respect to the shafts 50 and can be moved along the shafts 50. That is, the movable member 1a is guided by the shafts 50 so as to move in the optical axis direction.

The coil 60 is wound around the four supporting column portions 32 of the base 30. The coil 60 is constituted by a first coil 61 and a second coil 62. The first coil 61 is wound around in a predetermined direction. The second coil 62 is wound around in the direction opposite to the winding direction of the first coil 61. If current is applied to the first coil 61 and the second coil 62, a magnetic field is generated on each circumference of the first coil 61 and the second coil 62. A force for moving the movable member 1a in the optical axis direction is generated with these magnetic fields and the magnets 20.

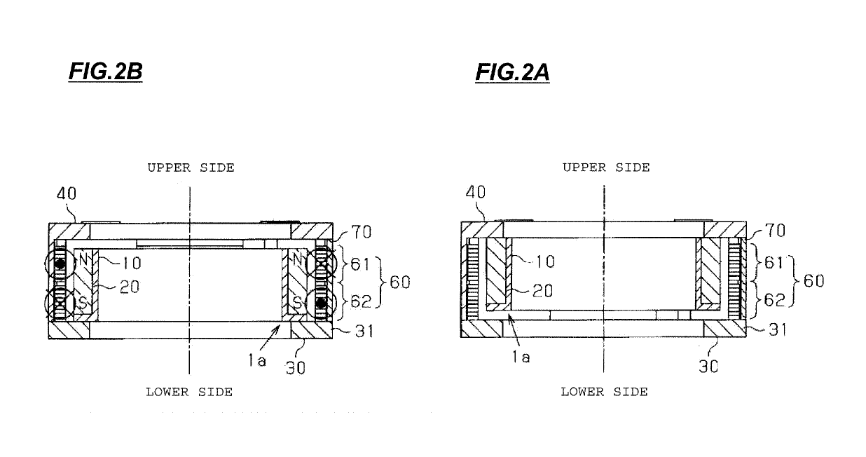

Next, a driving operation of the lens driving device 1 is described with reference to FIGS. 2A and 2B. An one-dotted chain line in FIGS. 2A and 2B indicates the optical axis direction. Further, in the drawings subsequent to FIGS. 2A and 2B, the lens holder RH in the movable member 1a is not illustrated.

In FIG. 2A, the movable member 1a is located at a home position. To be more specific, a lower surface of the holder 10 of the movable member 1a is in contact with an upper surface of the base portion 31 of the base 30. When the movable member 1a is located at the home position, no current is applied to the coil 60.

If current is applied to the coil 60, that is, if current in the directions indicated in FIG. 2B is applied to the first coil 61 and the second coil 62, the movable member 1a moves to a position as illustrated in FIG. 2B. To be more specific, if current is applied to the first coil 61 and the second coil 62, a magnetic field is generated on each circumference of the first coil 61 and the second coil 62. Then, a magnetic circuit is formed by the magnetic fields and the magnets 20 so that a force for moving the movable member 1a toward the upper side in the optical axis direction is generated. With the generated force, the movable member 1a is moved toward the upper side in the optical axis direction to the position as illustrated in FIG. 2B from the home position as illustrated in FIG. 2A.

On the other hand, if current in the directions opposite to the directions as illustrated in FIG. 2B is applied to the first coil 61 and the second coil 62, a magnetic circuit is formed by the magnetic fields and the magnets 20 so that a force for moving the movable member 1a toward the lower side in the optical axis direction is generated. That is, the movable member 1a is moved from the position as illustrated in FIG. 2B to the home position. It is to be noted that marks added to the coil 60 as illustrated in FIG. 2B indicate the following directions. That is, black circle marks in circles indicate a direction toward an observer of the drawing and cross marks in circles indicate a direction away from the observer of the drawing.

The lens is moved to an on-focus position while the movable member 1a is moved to the upper side and the lower side in the optical axis direction as described above. At this time, the movable member 1a is slidingly moved with respect to the two shafts 50 with magnetic forces generated between the two magnetic plates 70 and the magnets 20 opposed to the magnetic plates 70 in the radial direction. Therefore, the movable member 1a is not easily influenced by gravity even in a case where the movable member 1a is moved in the vertical direction. In addition, even if the current applied to the coil 60 is blocked after the lens has been moved to the on-focus position, the movable member 1a is kept at the on-focus position with the magnetic forces generated between the two magnetic plates 70 and the magnets 20.

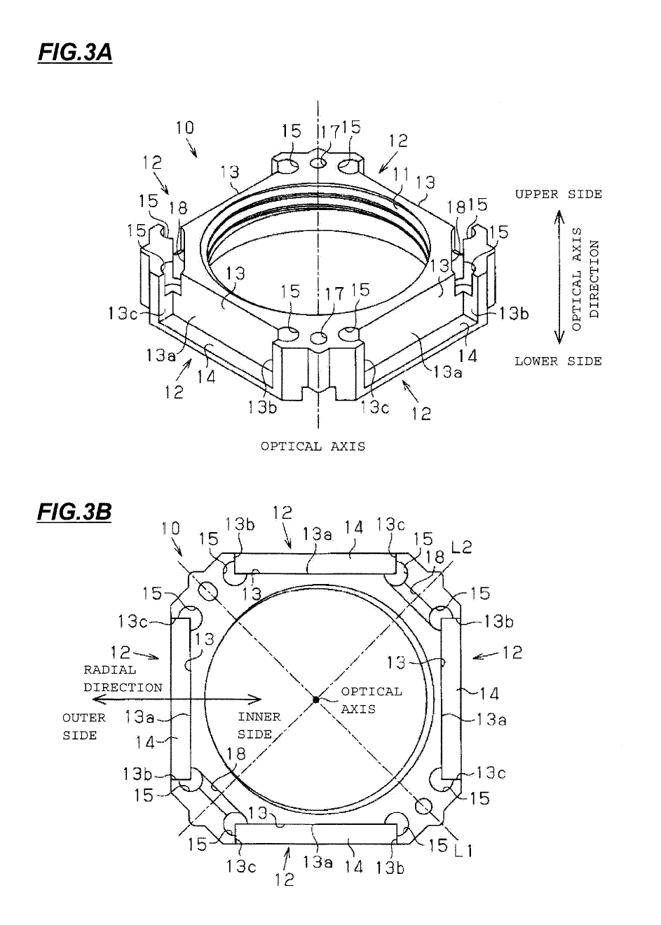

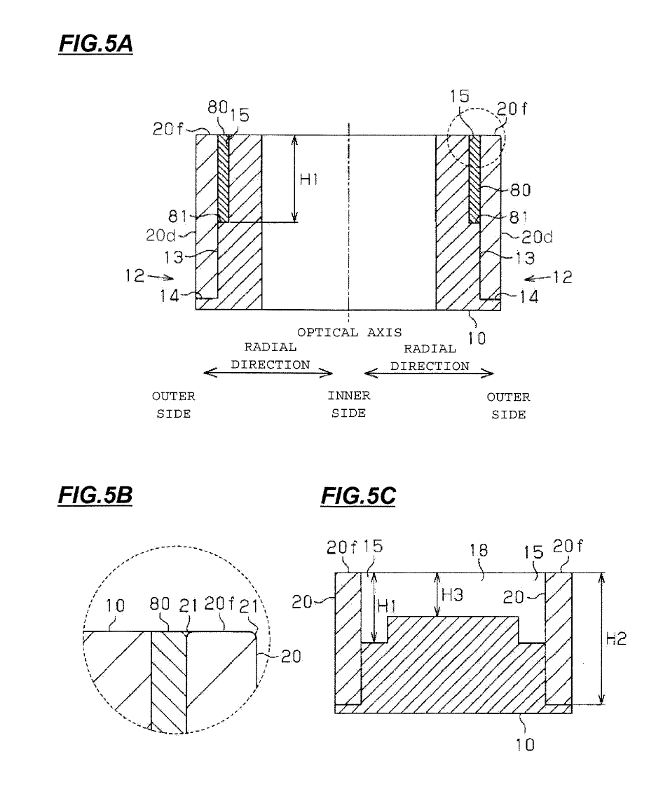

Next, a configuration of the movable member 1a is described in detail with reference to FIG. 3A through FIG. 6. It is to be noted that in FIGS. 5A and 5B, shaded portions on adhesive sump portions 80 indicate an adhesive.

As illustrated in FIG. 3A, the holder 10 is integrally formed into a substantially octagonal columnar shape by subjecting a resin material to injection molding. Further, an opening 11 and holding portions 12 are provided on the holder 10. The opening 11 is a circular through hole for accommodating the lens. The holding portions 12 hold the magnets 20.

As illustrated in FIG. 3B, first holding surfaces 13 and second holding surfaces 14 are provided on the holding portions 12. The first holding surfaces 13 are formed so as to be along the optical axis direction at the inner side with respect to side surfaces of the holder 10 in the radial direction. The second holding surfaces 14 are provided so as to extend toward the outer side in the radial direction from lower ends of the first holding surfaces 13 in the optical axis direction. Each of the first holding surfaces 13 is formed by three surfaces 13a, 13b, 13c and forms a concave shape concaved to the inner side with respect to each side surface of the holder 10 in the radial direction. Further, upper ends of the first holding surfaces 13 in the optical axis direction are connected to an upper end surface of the holder 10. The second holding surfaces 14 are formed on planes perpendicular to the optical axis direction. Outer edges of the second holding surfaces 14 in the radial direction are connected to the side surfaces of the holder 10.

Further, concave portions 15 are formed on the holding portions 12 between two surfaces 13a, 13b perpendicular to each other and between two surfaces 13a, 13c perpendicular to each other among the first holding surfaces 13. A length of each concave portion 15 in the optical axis direction is approximately half of a length of each first holding surface 13 in the optical axis direction. Each concave portion 15 is formed into a circular arc shape concaved toward the magnet 20 which is adjacent in the circumferential direction when seen from the above in the optical axis direction.

Further, through holes 17 are provided between the holding portions 12 which are adjacent to each other in the circumferential direction of the holder 10. The shafts 50 are inserted into the through holes 17. Thus, the holder 10 is guided by the shafts 50 at the time of the movement in the optical axis direction. It is to be noted that in the holder 10 according to the embodiment, two through holes 17 are provided on a diagonal line.

In addition, two cut-out portions 18 are provided on the upper end surface of the holder 10 in the optical axis direction at positions between the holding portions 12 which are adjacent to each other in the circumferential direction. Concave portions 15 which are adjacent to each other in the circumferential direction are communicated with each other through the cut-out portions 18 and the concave portions 15 serving as communicating grooves. It is to be noted that in the holder 10 according to the embodiment, two cut-out portions 18 are provided on the upper surface of the holder 10 at positions on a second diagonal line L2 of the holder 10. The second diagonal line L2 is perpendicular to a first diagonal line L1 on which the through holes 17 are provided.

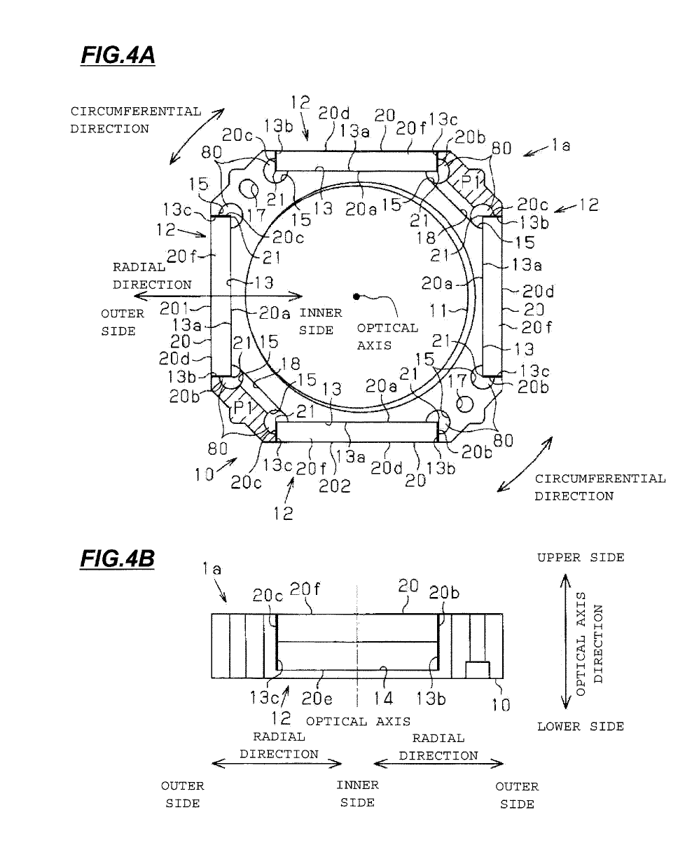

As illustrated in FIGS. 4A and 4B, the magnets 20 are attached to the holding portions 12. To be more specific, three surfaces 20a through 20c other than outer side surfaces 20d opposed to the coil 60 in the radial direction among side surfaces of the magnets 20 make contact with the three surfaces 13a through 13c of the first holding surfaces 13, respectively. Further, lower end surfaces 20e of the magnets 20 make contact with the second holding surfaces 14.

Further, as illustrated in FIG. 4A, spaces between the magnets 20 and the concave portions 15 constitute the adhesive sump portions 80 having hole shapes. An adhesive is filled into the adhesive sump portions 80 and the cut-out portions 18. A thermosetting adhesive is used as the adhesive according to the embodiment. An adhesive having a relatively low viscosity (for example, viscosity is equal to or lower than 100 Pa·s) is used as the adhesive. Therefore, the adhesive filled into the adhesive sump portions 80 lies between the three surfaces 20a through 20c among the side surfaces of the magnets 20 and the first holding surfaces 13 and between the lower end surfaces 20e of the magnets 20 and the second holding surfaces 14.

Here, as illustrated in FIG. 5A, if a length H1 of each concave portion 15 in the optical axis direction is set to be approximately half of a length H2 of each first holding surface 13 in the optical axis direction, the strength of the holder 10 itself can be suppressed from being lowered in comparison with a case where the lengths of each concave portion 15 and each first holding surface 13 in the optical axis direction are equal to each other. As illustrated in FIG. 5C, a length H3 of each cut-out portion 18 in the optical axis direction is set to be smaller than the length H1 of each concave portion 15 in the optical axis direction. Therefore, the strength of the holder 10 itself can be suppressed from being lowered in comparison with a case where the lengths of each cut-out portion 18 and each concave portion 15 in the optical axis direction are equal to each other.

Further, in a case where each of the lengths H1, H3 of each concave portion 15 and each cut-out portion 18 in the optical axis direction is set to be equal to the length H2 of each first holding surface 13 in the optical axis direction, a thickness of connecting portions between portions P1 (that is, portions of shaded areas in FIG. 4A) and portions at the inner side with respect to the cut-out portions 18, in the radial direction in the optical axis direction is decreased. Each of the portions P1 is surrounded by the holding portions 12 which are adjacent to each other in the circumferential direction, the cut-out portion 18 and the side surface of the holder 10. In other words, in such case, the thickness between the lower end surface of the holder 10 and the bottoms of the cut-out portions 18 and the concave portions 15 in the optical axis direction (thickness indicated by a difference between H2 and H3 in the optical axis direction in FIG. 5C) is decreased. As a result, the resin material is hard to flow to each connecting portion, resulting in deterioration in the molding property of the holder 10. In order to solve the problem, in the embodiment, each of the lengths H1, H3 of each concave portion 15 and each cut-out portion 18 in the optical axis direction is formed to be smaller than the length H2 of each first holding surface 13 in the optical axis direction. Therefore, the molding property of the holder 10 can be suppressed from being deteriorated.

Further, as illustrated in FIG. 5A, positions of the outer side surfaces 20d in the radial direction among the side surfaces of the magnets 20 are substantially identical to the positions of the side surfaces of the holder 10 in the radial direction. In addition, the positions of the upper end surfaces 20f of the magnets 20 in the optical axis direction are substantially identical to the position of the upper end surface of the holder 10 in the optical axis direction.

In addition, as illustrated in FIG. 5B, the adhesive is filled into the adhesive sump portions 80 and the cut-out portions 18 to the upper end surface of the holder 10 and the upper end surfaces 20f of the magnets 20. That is to say, the adhesive is filled so as to cover the corners 21 of the magnets 20 from the upper side in the optical axis direction. Therefore, the adhesive serves as drag for suppressing the magnets 20 from moving to the upper side with respect to the holder 10 in the optical axis direction.

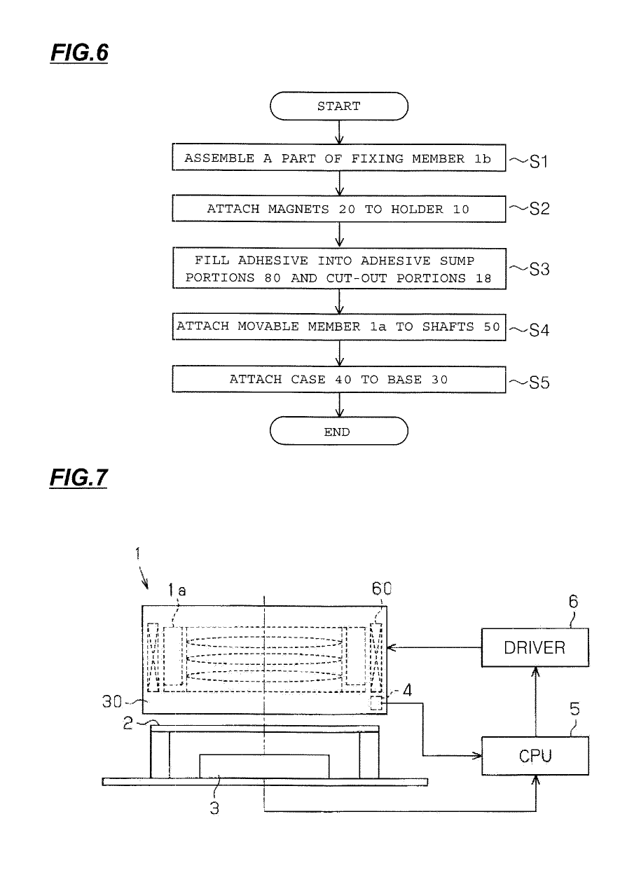

Next, a method of manufacturing the lens driving device 1 is described with reference to FIG. 6.

At first, a part of the fixing member 1b is assembled in step S1. To be more specific, the coil 60 is wound around the four supporting column portions 32 provided on the base 30. Then, the shafts 50 are fixed to the base 30. In the embodiment, step S2 corresponds to a first process and step S3 corresponds to a second process.

Next, the magnets 20 are attached to the holder 10 in step S2. To be more specific, the magnets 20 are inserted into each of the holding portions 12 of the holder 10. Here, the concave portions 15 and the magnets 20 provided on the holding portions 12 constitute the adhesive sump portions 80.

Thereafter, the adhesive is filled into the adhesive sump portions 80 and the cut-out portions 18 in step S3. Here, the adhesive sump portions 80 and the cut-out portion 18 at two places are connected to each other so that the adhesive is filled into the adhesive sump portions 80 and the cut-out portion 18 at once. Accordingly, in the embodiment, it is sufficient that the adhesive is filled at only six places. The movable member 1a is assembled by operations in step S2 and step S3.

Then, the movable 1a is attached to the shafts 50 in step S4. To be more specific, the shafts 50 are inserted into each of the through holes 17 of the holder 10 of the movable 1a. Finally, the case 40 is attached to the base 30 in step S5. To be more specific, the case 40 is locked to the base 30 and the shafts 50 are inserted into the through holes 41 of the case 40. Thus, the lens driving device 1 is assembled.

Next, a configuration of a camera module when the lens driving device 1 according to the embodiment is mounted on a camera is described with reference to FIG. 7.

As illustrated in FIG. 7, a filter 2 and an image sensor 3 are arranged at the side of the base 30 of the lens driving device 1. That is, the filter 2 and the image sensor 3 are arranged at the lower side of the base 30 in the optical axis direction. A hall element 4 as a position detection element is arranged on the base 30. A position of the movable member 1a is detected based on a signal from the hall element 4.

At the time of a focus operation, a Central Processing Unit (CPU) 5 controls a driver 6 to move the movable member 1a to the upper side in the optical axis direction from the home position to a position which has been previously set. At this time, the position detection signal from the hall element 4 is input to the CPU 5. At the same time, the CPU 5 processes a signal input from the image sensor 3 to acquire a contrast value of a captured image. Then, a position of the movable member 1a at which the contrast value is the best is acquired as an on-focus position.

Thereafter, the CPU 5 drives the movable 1a toward the on-focus position. At this time, the CPU 5 monitors a signal from the hall element 4 and drives the movable member 1a until the signal from the hall element 4 is made into a state corresponding to the on-focus position. Therefore, the movable 1a is positioned at the on-focus position.

With the lens driving device 1 according to the embodiment, effects as will be described below can be achieved.

(1) In the embodiment, the cut-out portions 18 as communicating grooves are provided on the holder 10 such that the magnets 20 which are adjacent to each other in the circumferential direction are communicated with each other through each cut-out portion 18. The adhesive is into the cut-out portions 18. With the configuration, the adhesive makes it possible to fix the magnets 20 which are adjacent to each other in the circumferential direction to each other so that bonding strength of the magnets 20 with respect to the holder 10 can be improved. That is, the magnets 20 can be suppressed from jouncing with respect to the holder 10. As a result, a problem that the magnets 20 move with respect to the holder 10 or are separated from the holder 10 in an extreme case due to the jouncing of the magnets 20 with respect to the holder 10 can be prevented from occurring.

Further, it is considered that forces in the direction along the cut-out portions 18 are applied to the magnets 20 by contraction forces generated when the adhesive filled into the cut-out portions 18 is cured. That is to say, it is considered that forces of pulling the magnets 20 toward the first holding surfaces 13 of the holder 10 are applied to the magnets 20 with component forces of the above forces. Therefore, the magnets 20 can be suppressed from jouncing with respect to the holder 10.

Moreover, one magnet 201 and the other magnet 202 are bonded to each other with the adhesive filled into the cut-out portion 18. Therefore, even if the one magnet 201 is about to jounce with respect to the holder 10, the one magnet 201 can be suppressed from jouncing with the other magnet 202. As a result, the magnets 20 can be suppressed from jouncing with respect to the holder 10.

(2) In the embodiment, the adhesive sump portions 80 are formed between the first holding surfaces 13 of the holder 10 and the magnets 20. With this configuration, when the adhesive sump portions 80 are formed, bonding areas between the magnets 20 and the holder 10 are increased so that the bonding strength between the holder 10 and the magnets 20 is improved. Accordingly, the magnets 20 can be suppressed from jouncing with respect to the holder 10.

Further, when the adhesive sump portions are provided on the side surfaces 20a of the magnets 20, the thickness from the inner surface constituting the opening 11 to the first holding surfaces 13 in the radial direction is needed at some degree. Accordingly, the holder 10 is increased in size in the radial direction in some case. On the other hand, in the embodiment, the adhesive sump portions 80 are constituted between the corners 21 of the magnets 20 and the concave portions 15 of the first holding portions 13. Therefore, the adhesive sump portions 80 are formed on portions having a large thickness between the first holding surfaces 13 and the inner surface of the opening 11 in the radial direction. Accordingly, a thickness of the center portion at which the thickness between the first holding surfaces 13 and the inner surface of the opening 11 is the thinnest can be made thinner. As a result, the holder 10 can be suppressed from being increased in size in the radial direction. Moreover, the concave portions 15 are formed at portions at which the thickness between the first holding surfaces 13 and the inner surface of the opening 11 in the radial direction is large. Therefore, the shapes of the concave portions 15 can be made large. Accordingly, the bonding areas between the magnets 20 and the holder 10 can be increased so that the magnets 20 can be suppressed from jouncing with respect to the holder 10.

(3) In the embodiment, the adhesive sump portions 80 have bottoms 81. For example, when the adhesive having a relatively low viscosity (for example, viscosity is equal to or lower than 100 Pa·s) is used as the adhesive, if the adhesive sump portions 80 penetrate through the holder 10, the adhesive leaks from the lower end surface of the holder 10 in the optical axis direction in some case. In order to solve the problem, in the embodiment, since the bottoms 81 are provided on the adhesive sump portions 80, the adhesive can be prevented from leaking from the lower end surface of the holder 10 in the optical axis direction.

(4) In the embodiment, the adhesive sump portions 80 each of which is provided on each of the magnets 20 which are adjacent to each other in the circumferential direction and each cut-out portion 18 are connected to each other. With this configuration, the bonding strength between the magnets 20 and the holder 10 is improved. Therefore, the magnets 20 can be suppressed from jouncing with respect to the holder 10. In addition, when the adhesive is filled, the adhesive can be filled into the adhesive sump portions 80 and the cut-out portion 18 at the same time. Therefore, a manufacturing process of the lens driving device 1 can be simplified.

(5) In the embodiment, the adhesive is filled so as to cover a part of the corners 21 of the magnets 20. With this configuration, the adhesive covering the corners 21 plays a role in restricting the movement of the magnets 20 with respect to the holder 10. Therefore, the magnets 20 can be suppressed from jouncing with respect to the holder 10.

(6) In the embodiment, the holder 10 is molded with a resin material. With this configuration, weight of the holder 10 can be reduced in comparison with a case where the holder is formed with a metal material. Accordingly, in the lens driving device 1, current needed for moving the holder 10 can be reduced and responsibility of the movement of the holder 10 at the time of driving of the lens driving device 1 can be improved.

In addition, the concave portions 15 and the cut-out portions 18 constituting the adhesive sump portions 80 are formed so as to be along the optical axis direction. With this configuration, a configuration of a mold for molding the holder 10 can be simplified in comparison with a case where the concave portions 15 and the cut-out portions 18 are formed on the side surfaces of the holder 10, that is, a case where the concave portions 15 and the cut-out portions 18 are formed so as to be along the radial direction. That is to say, molds for molding the concave portions 15 and the cut-out portions 18 can be eliminated.

(7) In the embodiment, the adhesive is filled into the adhesive sump portions 80 and the cut-out portions 18 after the magnets 20 are attached to the holder 10. Here, for example, when the magnets 20 are attached to the holder 10 after the adhesive is coated on the first holding surfaces 13 of the holder 10, if the adhesive having a relatively low viscosity is used, the adhesive leaks to the side surfaces of the holder 10 in some case after the adhesive is coated on the first holding surfaces 13. Particularly in the embodiment, the magnets 20 and the coil 60 are opposed to each other in the radial direction. Therefore, if the adhesive is cured in a state where the adhesive leaks to the side surfaces of the holder 10, the leaked adhesive and the coil 60 make contact with each other in some case when the movable member 1a is moved. As a result, a frictional force at the time of the movement of the movable member 1a is increased with the leaked adhesive. In the worst case, the operation of the movable member 1a is stopped. In order to solve the problem, in the embodiment, the adhesive is filled into the adhesive sump portions 80 and the cut-out portions 18 after the magnets 20 are attached to the holder 10. Therefore, the adhesive can be suppressed from leaking outside the magnets 20 and to the side surfaces of the holder 10, that is, outside the movable member 1a. As a result, the coil 60 can be suppressed from being damaged.

(8) In the embodiment, when the adhesive is filled, the adhesive is filled into the adhesive sump portions 80 and the cut-out portions 18 at the same time. With this configuration, the manufacturing process of the lens driving device 1 can be simplified. As a result, cost of the lens driving device 1 can be reduced.

(9) In the embodiment, the holding portions 12 are provided on the holder 10 and the magnets 20 are inserted into the holding portions 12. Further, the positions of the outer side surfaces 20d of the magnets 20 in the radial direction are substantially identical to positions of the side surfaces of the holder 10 in the radial direction. With this configuration, spaces between the magnets 20 and the coil 60 in the radial direction can be made smaller in comparison with a case where the magnets 20 are arranged on openings provided at the inner side with respect to the side surfaces of the holder 10 in the radial direction. Accordingly, magnetic forces between the magnets 20 and the coil 60 can be improved. In addition, widths from the outer side surfaces of the magnets 20 to the side surfaces of the holder 10 can be eliminated, thereby reducing width of the movable member 1a in the radial direction.

Further, the bonding strength of the magnets 20 with respect to the holder 10 can be improved in comparison with a case where the magnets 20 are fixed to the side surfaces of the holder 10. Accordingly, the magnets 20 can be suppressed from jouncing with respect to the holder 10.

(10) In the embodiment, neodymium magnets are used as the magnets 20. Therefore, volumes of the magnets 20 can be decreased in comparison with a case where ferrite magnets are used on the assumption that they have the same magnetic forces. As a result, the movable member 1a can be reduced in size.

(11) In the embodiment, the lens driving device 1 is mounted on a camera module of a mobile phone. In particular, in mobile devices such as a mobile phone, an external impact is applied to the lens driving device 1 in some case when these devices fall, and so on. In such case, the external impact is largely applied to the movable member 1a which is movable in the optical axis direction. As a result, the magnets 20 jounce with respect to the holder 10 in some case if the force is applied to the bonding portions between the holder 10 and the magnets 20. On this point, in the embodiment, the magnets 20 which are adjacent to each other in the circumferential direction are bonded to each other with the adhesive filled into the cut-out portions 18 and the holder 10 and the magnets 20 are bonded to each other with the adhesive filled into the adhesive sump portions 80. Therefore, the bonding strength between the holder 10 and the magnets 20 is improved. As a result, the magnets 20 can be suppressed from jouncing with respect to the holder 10 due to the external impact. Therefore, it is preferable that the lens driving device 1 according to the embodiment is mounted on the above mobile phone.

### Other Embodiments

The invention is not limited to the embodiment as described above and can be changed as follows.

For example, the lens driving device 1 according to the embodiment is applied to a camera module mounted on a mobile phone. However, an application range of the invention is not limited thereto. For example, the lens driving device 1 may be applied to a camera module mounted on other mobile devices.

Further, in the lens driving device 1 according to the embodiment, the adhesive sump portions 80 have bottoms with the second holding surfaces 14. However, the shape of the adhesive sump portions 80 is not limited thereto. For example, the adhesive sump portions 80 may be through holes penetrating through the holder 10 in the optical axis direction. The configuration is preferable when an adhesive having a relatively high viscosity (for example, viscosity is higher than 100 Pa·s) is used as the adhesive. That is to say, in the case of the adhesive having a relatively high viscosity, if the bottoms are formed on the adhesive sump portions, when the adhesive is filled, air which has been previously present in the adhesive sump portions is not discharged outside the holder 10 in some case. However, if the adhesive sump portions penetrate through the holder 10 in the optical axis direction, the air which has been present in the adhesive sump portions before the adhesive is filled is discharged outside the holder 10 through the through holes as the adhesive is filled. Accordingly, a problem that the bonding strength between the magnets 20 and the holder 10 is deteriorated because the air lies in the adhesive filled into the adhesive sump portions 80 can be suppressed from occurring. Therefore, it is desirable that when the viscosity of the adhesive is equal to or lower than 100 Pa·s, the adhesive sump portions 80 having the bottoms are formed and when the viscosity of the adhesive is higher than 100 Pa·s, the adhesive sump portions 80 having the through holes are formed.

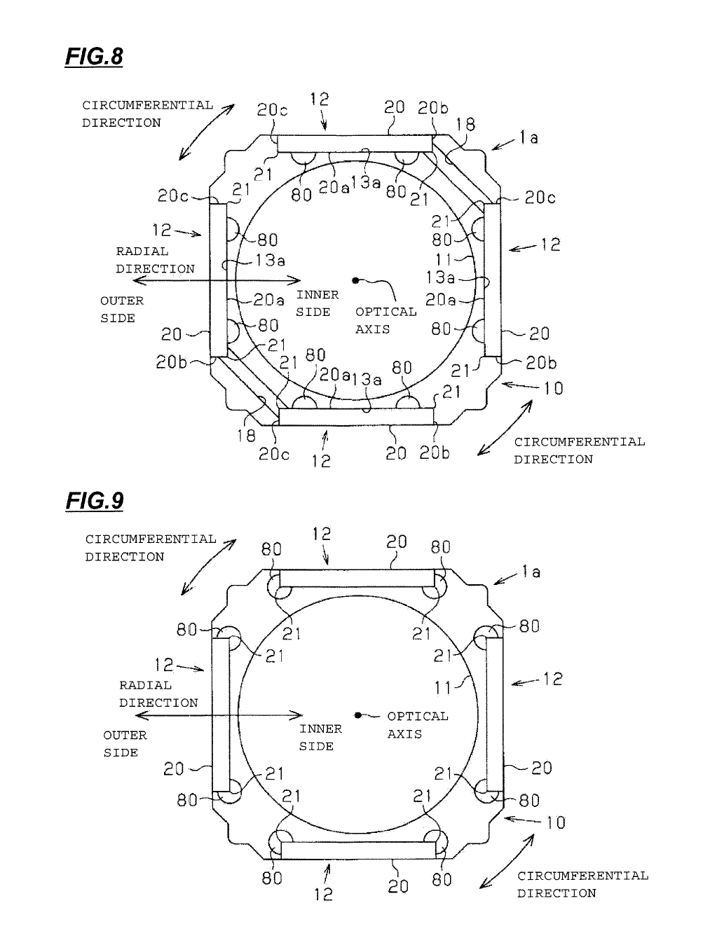

Further, in the lens driving device 1 according to the embodiment, the adhesive sump portions 80 are formed between the corners 21 of the magnets 20 and the concave portions 15. However, the configuration of the adhesive sump portions 80 is not limited thereto. For example, as illustrated in FIG. 8, the adhesive sump portions 80 may be provided between the side surfaces 20a of the magnets 20 and the side surfaces 13a of the first holding surfaces 13 opposed to the side surfaces 20a of the magnets 20 in the radial direction. In FIG. 8, semi-circular columnar concave portions from the upper ends of the side surfaces 13a to the lower side in the optical axis direction are formed on the side surfaces 13a. Further, the adhesive sump portions 80 are formed between the concave portions and the side surfaces 20a of the magnets 20. It is to be noted that in FIG. 8, although the number of adhesive sump portions 80 is two, the number of adhesive sump portions 80 is not limited to two and may be one or three or more.

Further, in the lens driving device 1 according to the embodiment, the adhesive sump portions 80 and the cut-out portions 18 are connected to each other. However, the positional relationship between the adhesive sump portions 80 and the cut-out portions 18 is not limited thereto. For example, as illustrated in FIG. 8, the adhesive sump portions 80 and the cut-out portions 18 may not be connected to each other. In this case, the cut-out portions 18 communicate side surfaces 20a, 20b of one magnet 20 and side surfaces 20a, 20c of the other magnet 20 in two magnets which are adjacent to each other in the circumferential direction to each other.

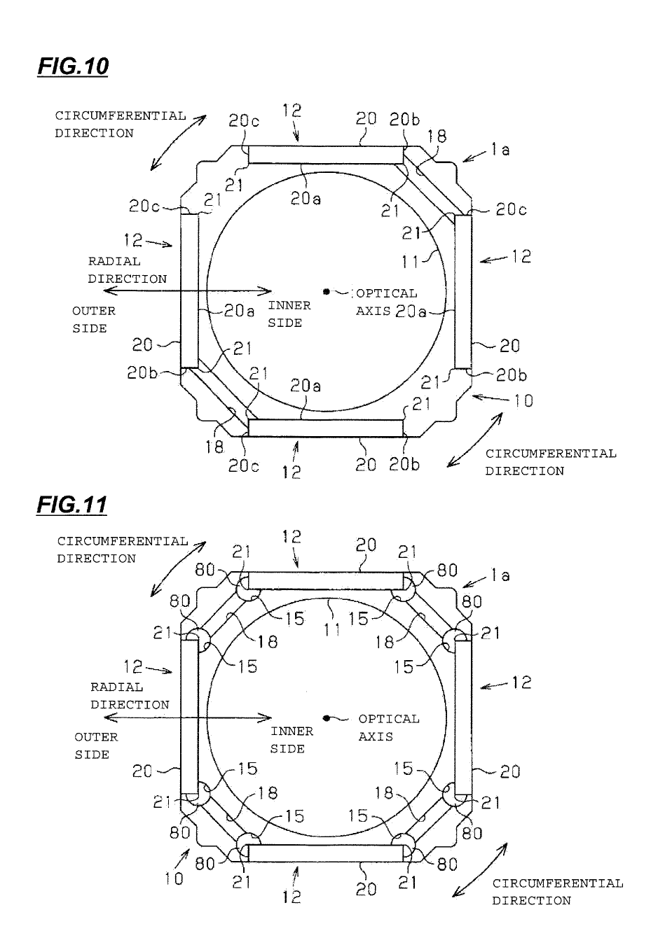

Further, in the lens driving device 1 according to the embodiment, both of the adhesive sump portions 80 and the cut-out portions 18 are provided on the holder 10. However, the shape of the holder 10 is not limited thereto. For example, as illustrated in FIG. 9, only adhesive sump portions 80 may be provided on the holder 10. With this configuration, the bonding area between the magnets 20 and the holder 10 with the adhesive is increased in comparison with a case where the adhesive sump portions 80 are not provided. Accordingly, the bonding strength between the magnets 20 and the holder 10 can be improved by the adhesive filled into the adhesive sump portions 80. As a result, the magnets 20 can be suppressed from jouncing with respect to the holder 10. Further, as illustrated in FIG. 10, only cut-out portions 18 may be formed on the holder 10. With this configuration, the effect (1) according to the embodiment can be achieved. In addition, even with the configuration of the lens driving device 1 as illustrated in FIG. 9 and FIG. 10, the adhesive is filled into the adhesive sump portions 80 or the cut-out portions 18 after the magnets 20 are attached to the holder 10. With these configurations, the effect (7) according to the above embodiment can be achieved.

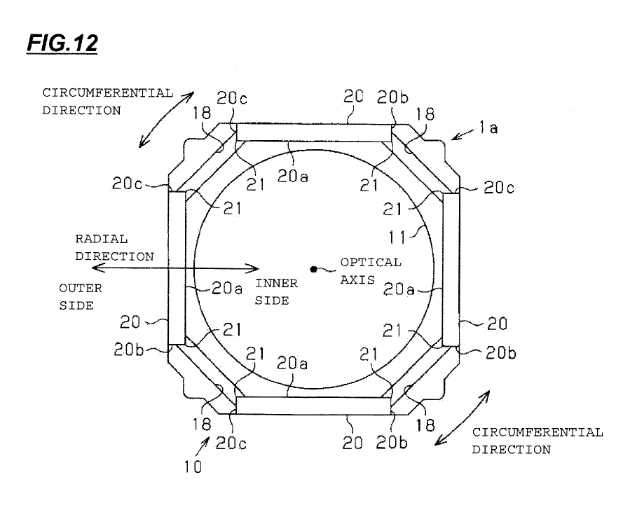

Further, in the lens driving device 1 according to the embodiment, only one-side side surfaces of the magnets 20 which are adjacent to each other in the circumferential direction are communicated with each other through each cut-out portion 18. However, the configuration of the cut-out portions 18 is not limited thereto. For example, as illustrated in FIG. 11, both-side side surfaces of the magnets 20 which are adjacent to each other in the circumferential direction may be communicated with each other through the cut-out portions 18. To be more specific, the cut-out portions 18 may be formed on all of the four places between the concave portions 15 which are adjacent to each other in the circumferential direction. Therefore, both side surfaces of one magnet may be communicated with the other side surfaces of two magnets which are adjacent to the one magnet. That is, the cut-out portions 18 may connect the adhesive sump portions 80 of the magnets which are adjacent to each other in the circumferential direction to each other. Therefore, all of four magnets which are adjacent to each other in the circumferential direction are bonded to each other with the adhesive filled into the cut-out portions 18 so that the four magnets 20 form one rigid body. With this configuration, each magnet 20 plays a role in suppressing the magnets which are adjacent to the magnet in the circumferential direction from jouncing. Therefore, the magnets 20 can be further suppressed from jouncing with respect to the holder 10. Further, in a case where the concave portions 15 are not formed, as illustrated in FIG. 12, the cut-out portions 18 are formed on all of four places between the holding portions 12 which are adjacent to each other in the circumferential direction. The side surfaces of the magnets 20 may be communicated with each other with these four cut-out portions 18.

Further, in the lens driving device 1 according to the embodiment, the holding portions 12 are provided on the holder 10. However, the shape of the holder 10 is not limited thereto. For example, a shape in which the holding portions 12 are not provided on the holder 10 and the magnets 20 are fixed to the side surfaces of the holder 10 maybe employed. Alternatively, a shape in which openings are provided on the inner side with respect to the side surfaces of the holder 10 in the radial direction and the magnets 20 are inserted into the openings may be employed.

Further, in the lens driving device 1 according to the embodiment, the adhesive sump portions 80 and the cut-out portions 18 are provided so as to be along the optical axis direction. However, the configuration of the adhesive sump portions 80 and the shape of the cut-out portions 18 are not limited thereto. For example, the adhesive sump portions 80 and the cut-out portions 18 may have shapes inclined toward the optical axis direction in the radial direction.

Further, in the lens driving device 1 according to the embodiment, the adhesive sump portions 80 and the cut-out portions 18 are provided on the end surface of the holder 10. However, the positions of the adhesive sump portions 80 and the cut-out portions 18 are not limited thereto. For example, the adhesive sump portions 80 and the cut-out portions 18 may be provided on the side surfaces of the holder 10.

Further, in the lens driving device 1 according to the embodiment, the length H1 of each concave portion 15 in the optical axis direction is substantially half of the length H2 of each first holding surface 13 in the optical axis direction. However, the length H1 of each concave portion 15 in the optical axis direction is not limited thereto. For example, the length H1 of each concave portion 15 in the optical axis direction may be formed so as to be equal to the length H2 of each first holding surface 13 in the optical axis direction. In this case, the concave portions 15 play a role as clearance portions for avoiding the corners 21 of the magnets 20 from making contact with the first holding surfaces 13. Accordingly, the corners 21 of the magnets 20 are avoided from making contact with the first holding surfaces 13 with the concave portions 15, thereby attaching the magnets 20 to the holder 10 with high accuracy. That is to say, the concave portions 15 have both of a role in avoiding the corners 21 of the magnets 20 from making contact with the first holding surfaces 13 and attaching the magnets 20 with high accuracy and a role in constituting the adhesive sump portions 80. As a result, shapes for playing these roles are not needed to be separately provided on the holder 10. Accordingly, the shape of the holder 10 can be simplified.

Further, in the lens driving device 1 according to the embodiment, the cut-out portions 18 are connected to the inner-side portions of the concave portions 15 in the radial direction. However, the shape of the cut-out portions 18 is not limited thereto. For example, as illustrated in FIG. 11, the cut-out portions 18 may have a shape connecting the concave portions 15 which are adjacent to each other in the circumferential direction with shortest distances. With this, a usage amount of the adhesive filled into the cut-out portions 18 can be reduced in comparison with a case where the cut-out portions have other shapes. Accordingly, the cost of the lens driving device 1 can be reduced.

Further, in the method of manufacturing the lens driving device 1 according to the embodiment, the shafts 50 are attached to the base 30 when the fixing member 1b is assembled in step S1, and instep S4 after that, the movable member 1a is inserted into the shafts 50. However, the order of the method of manufacturing the lens driving device 1 is not limited thereto. For example, a method in which after the movable member 1a is accommodated in the base 30, the shafts 50 are inserted into the movable member 1a, and then, the shafts 50 are attached to the base 30 may be employed.

In addition to the above modifications, the embodiment of the invention can be variously modified as appropriate in a range of a technical scope as described in the scope of the invention.

It is to be noted that in the above embodiment and modifications, the hall element 4 corresponds to “position detection element” described in claims, the first holding surface 13 corresponds to “holding surface” described in the claims, the concave portion 15 corresponds to “clearance portion” described in the claims, and the cut-out portion 18 corresponds to “communicating groove” described in the claims.

What is claimed is:

1. A lens driving device comprising:
a holder which holds a lens and is movable in the direction of an optical axis of the lens; and
a plurality of magnets which surrounds the lens from a radial direction and is fixed to the holder so as to be separated from each other,
wherein communicating grooves through which the magnets which are adjacent to each other are communicated with each other and into which an adhesive is filled are provided on the holder, and
the magnets which are adjacent to each other are bonded to each other with the adhesive filled into the communicating grooves.

2. The lens driving device according to claim 1,
wherein the communicating grooves are provided at all of places between the magnets which are adjacent to each other, and
all of the magnets which are adjacent to each other are bonded to each other with the adhesive filled into the communicating grooves.

3. The lens driving device according to claim 1,
wherein adhesive sump portions are provided on the holder, the adhesive sump portions being configured such that hole shapes are formed between the adhesive sump portions and side surfaces of the magnets, and an adhesive is filled into each adhesive sump portion,
the magnets are fixed to the holder with the adhesive filled into the adhesive sump portions.

4. The lens driving device according to claim 3,
wherein a plurality of the adhesive sump portions corresponding to the magnets is provided, and
the adhesive sump portions which are provided on each of the magnets which are adjacent to each other are communicated with each other through the communicating grooves.

5. The lens driving device according to claim 3,
wherein holding portions opened in the radial direction are provided on the holder at positions corresponding to the magnets and holding surfaces extended in the direction of the optical axis are provided on the holding portions,
clearance portions for avoiding the holding surfaces from making contact with corners of the magnets are provided on the holding surfaces, and
the adhesive sump portions are formed into hole shapes between the clearance portions and side surfaces of the corners of the magnets.

6. The lens driving device according to claim 3,
wherein the adhesive sump portions penetrate through the holder in the direction of the optical axis.

7. The lens driving device according to claim 3,
wherein the adhesive sump portions are configured such that openings each having a bottom and extending in the direction of the optical axis are formed between the adhesive sump portions and the magnets.

8. A lens driving device comprising:
a holder which holds a lens and is movable in the direction of an optical axis of the lens; and
a plurality of magnets which surrounds the lens from a radial direction and is fixed to the holder so as to be separated from each other,
wherein adhesive sump portions are provided on the holder, the adhesive sump portions being configured such that hole shapes are formed between the adhesive sump portions and side surfaces of the magnets, and an adhesive is filled into each adhesive sump portion, and
the magnets are fixed to the holder with the adhesive filled into the adhesive sump portions.

9. The lens driving device according to claim 8,
wherein holding portions opened in the radial direction are provided on the holder at positions corresponding to the magnets and holding surfaces extended in the direction of the optical axis are provided on the holding portions,
clearance portions for avoiding the holding surfaces from making contact with corners of the magnets are provided on the holding surfaces, and
the adhesive sump portions are formed into hole shapes between the clearance portions and side surfaces of the corners of the magnets.

10. The lens driving device according to claim 8,
wherein the adhesive sump portions penetrate through the holder in the direction of the optical axis.

11. The lens driving device according to claim 8,
wherein the adhesive sump portions are configured such that openings each having a bottom and extending in the direction of the optical axis are formed between the adhesive sump portions and the magnets.

12. A camera module comprising:
a lens driving device; and
an image capturing portion on which light enters through a lens held by the lens driving device,
wherein the lens driving device includes:
a holder which holds the lens and is movable in the direction of an optical axis of the lens; and
a plurality of magnets which surrounds the lens from a radial direction and is fixed to the holder so as to be separated from each other,
communicating grooves through which the magnets which are adjacent to each other are communicated with each other and into which an adhesive is filled are provided on the holder, and
the magnets which are adjacent to each other are bonded to each other with the adhesive filled into the communicating grooves.

13. The camera module according to claim 12,
wherein the communicating grooves are provided at all of places between the magnets which are adjacent to each other, and all of the magnets which are adjacent to each other are bonded to each other with the adhesive filled into the communicating grooves.

14. The camera module according to claim 12,
wherein adhesive sump portions are provided on the holder, the adhesive sump portion being configured such that hole shapes are formed between the adhesive sump portions and side surfaces of the magnets, and an adhesive is filled into each adhesive sump portion, and
the magnets are fixed to the holder with the adhesive filled into the adhesive sump portions.

15. The camera module according to claim 14,
wherein a plurality of the adhesive sump portions corresponding to the magnets is provided, and
the adhesive sump portions which are provided on each of the magnets which are adjacent to each other are communicated with each other through the communicating grooves.

16. The camera module according to claim 14,
wherein holding portions opened in the radial direction are provided on the holder at positions corresponding to the magnets and holding surfaces extended in the direction of the optical axis are provided on the holding portions,
clearance portions for avoiding the holding surfaces from making contact with corners of the magnets are provided on the holding surfaces, and
the adhesive sump portions are formed into hole shapes between the clearance portions and side surfaces of the corners of the magnets.

17. The camera module according to claim 14,
wherein the adhesive sump portions penetrate through the holder in the direction of the optical axis.

18. The camera module according to claim 14,
wherein the adhesive sump portions are configured such that openings each having a bottom in the direction of the optical axis are formed between the adhesive sump portions and the magnets.
